(19) United States
(12) Patent Application Publication
(10) Pub. No.: US 2022/0146110 A1
(43) Pub. Date: May 12, 2022

(54) HEATING COOKING APPARATUS

(71) Applicant: SHARP KABUSHIKI KAISHA, Sakai City (JP)

(72) Inventors: MUNESATO KUMAGAI, Sakai City (JP); JUNKI ASAI, Sakai City (JP)

(21) Appl. No.: 17/467,417

(22) Filed: Sep. 6, 2021

(30) Foreign Application Priority Data
Nov. 9, 2020 (JP) 2020-186496

(51) Int. Cl. F24C 7/08; F24C 15/00; H05B 6/64; H05B 6/68; F24C 7/02

(52) U.S. Cl. CPC F24C 7/085; F24C 15/006; F24C 7/02; H05B 6/6447; H05B 6/687; H05B 6/642

(57) ABSTRACT

A heating cooking apparatus includes a heating chamber, a first detection unit, and a first interposed member. The heating chamber accommodates an object to be heated. The first detection unit is spaced apart from the heating chamber and detects sound in the heating chamber. The first interposed member is interposed between the heating chamber and the first detection unit and extends from the first detection unit toward the heating chamber. The first interposed member includes a through hole that passes the sound.

### CROSS-REFERENCE TO RELATED APPLICATIONS

This application claims the benefit of priority to Japanese Patent Application Number 2020-186496 filed on Nov. 9, 2020. The entire contents of the above-identified application are hereby incorporated by reference.

### TECHNICAL FIELD

The disclosure relates to a heating cooking apparatus.

### BACKGROUND

Heating cooking apparatuses such as microwave ovens, ovens, and toasters have been known (refer to, for example, JP 6579301 B). The heating cooking apparatus of JP 6579301 B includes a heating chamber and an image capturing unit. The heating chamber accommodates a food product. A through hole is formed in a side wall surface of the heating chamber. The image capturing unit captures an image of an inside of the heating chamber through the through hole.

In a heating cooking apparatus such as that of JP 6579301 B, an image of the inside of the heating chamber is captured by the image capturing unit, making it possible for a user to visually observe the captured image and thus identify a progress of cooking. Accordingly, overcooking and undercooking of the food product can be suppressed.

### SUMMARY

Nevertheless, in a heating cooking apparatus such as that of JP 6579301 B, the user needs to visually observe the image in order to identify the progress of cooking. Accordingly, the user temporarily stops other tasks, making visual observation cumbersome for the user.

The disclosure has been made in view of the above-described problems, and an object thereof is to provide a heating cooking apparatus that makes it possible to identify a progress of cooking without visual observation.

A heating cooking apparatus according to an aspect of the disclosure includes a heating chamber, a first detection unit, and an interposed member. The heating chamber is configured to accommodate an object to be heated. The first detection unit is spaced apart from the heating chamber and configured to detect sound in the heating chamber. The interposed member is interposed between the heating chamber and the first detection unit and extends from the first detection unit toward the heating chamber. The interposed member includes a through hole configured to pass the sound.

According to the disclosure, it is possible to provide a heating cooking apparatus that makes it possible to identify a progress of cooking without visual observation.

### BRIEF DESCRIPTION OF DRAWINGS

The disclosure will be described with reference to the accompanying drawings, wherein like numbers reference like elements.

FIG. 1 is a schematic front view illustrating an appearance of a heating cooking apparatus according to a first embodiment of the disclosure.

FIG. 2 is a schematic cross-sectional view illustrating, from a front surface side, an internal structure of the heating cooking apparatus according to the first embodiment.

FIG. 3 is a schematic cross-sectional view illustrating, from above, the internal structure of the heating cooking apparatus according to the first embodiment.

FIG. 4 is a block diagram illustrating a configuration of the heating cooking apparatus according to the first embodiment.

FIG. 5 is a cross-sectional view illustrating a structure around a first detection unit, a first interposed member, a second detection unit, and a second interposed member according to the first embodiment.

FIG. 6 is a perspective view illustrating a structure of the first detection unit and the second detection unit according to the first embodiment.

FIG. 7 is a cross-sectional view illustrating the structure of the first detection unit and the second detection unit according to the first embodiment.

FIG. 8 is a diagram illustrating a structure of the first interposed member and the second interposed member according to the first embodiment.

FIG. 9 is a diagram illustrating a processing flow of the heating cooking apparatus according to the first embodiment.

FIG. 10 is a diagram illustrating a structure of the first interposed member and the second interposed member according to a first modified example.

FIG. 11 is a diagram illustrating a structure of the first interposed member and the second interposed member according to a second modified example.

FIG. 12 is a diagram illustrating a structure of the first interposed member and the second interposed member according to a third modified example.

FIG. 13 is a diagram illustrating a structure of the first interposed member and the second interposed member according to a fourth modified example.

FIG. 14 is a cross-sectional view illustrating a structure around the first detection unit, the first interposed member, the second detection unit, and the second interposed member according to a fifth modified example.

FIG. 15 is a schematic cross-sectional view illustrating, from above, an internal structure of a heating cooking apparatus according to a second embodiment of the disclosure.

FIG. 16 is a diagram illustrating a generation flow of sound data by a control unit according to a third embodiment of the disclosure.

### DESCRIPTION OF EMBODIMENTS

Below, embodiments of a heating cooking apparatus according to the disclosure will be described with reference to, the drawings. Note that, in the drawings, the same or equivalent components are denoted by the same reference signs and description thereof will not be repeated. Further, in this embodiment, an X axis, a Y axis, and a Z axis orthogonal to each other are illustrated in the drawings. The Z axis is parallel to a vertical direction, and the X and Y axes are parallel to a horizontal direction. A positive direction of the Y axis indicates a back surface side of the heating cooking apparatus, and a negative direction of the Y axis indicates a front surface side of the heating cooking apparatus. In this embodiment, for the sake of convenience, the front surface side of the heating cooking apparatus may be described as a front side of the heating cooking apparatus, and the back surface side of the heating cooking apparatus may be described as a rear side of the heating cooking apparatus. Further, for the sake of convenience, a Z-axis direction may be described as an up-down direction. A positive direction of the Z axis indicates an upward direction. However, the up-down direction, the upward direction, and a downward direction are determined for convenience of description, and need not correspond to the vertical direction. Further, the up-down direction is merely defined for the sake of convenience of description, and an orientation of the heating cooking apparatus according to the disclosure during use and assembly is not limited.

### First Embodiment

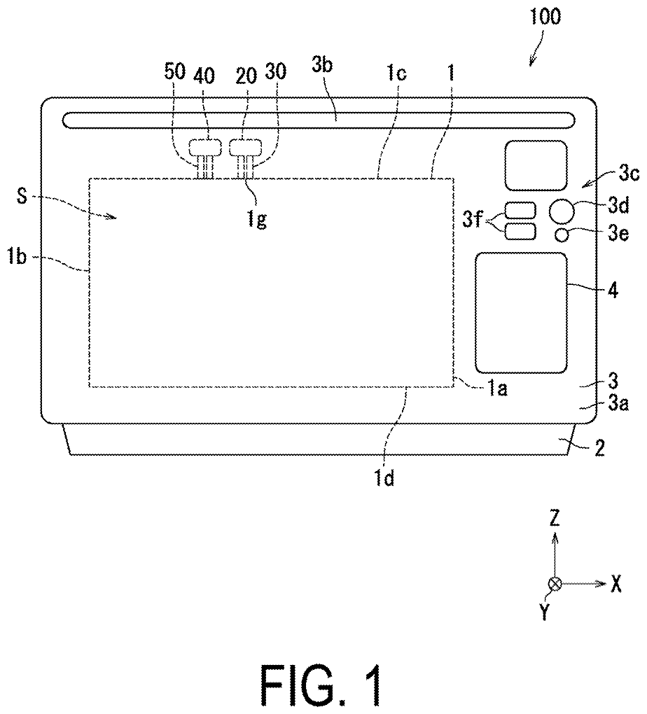

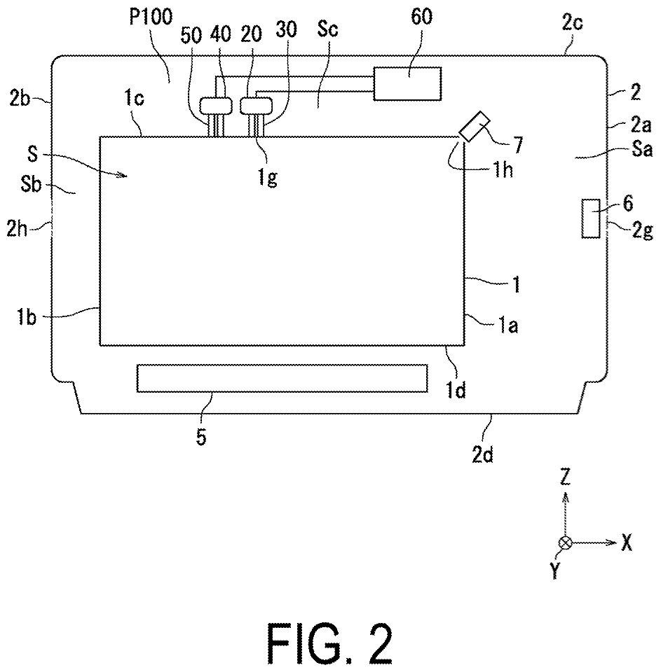

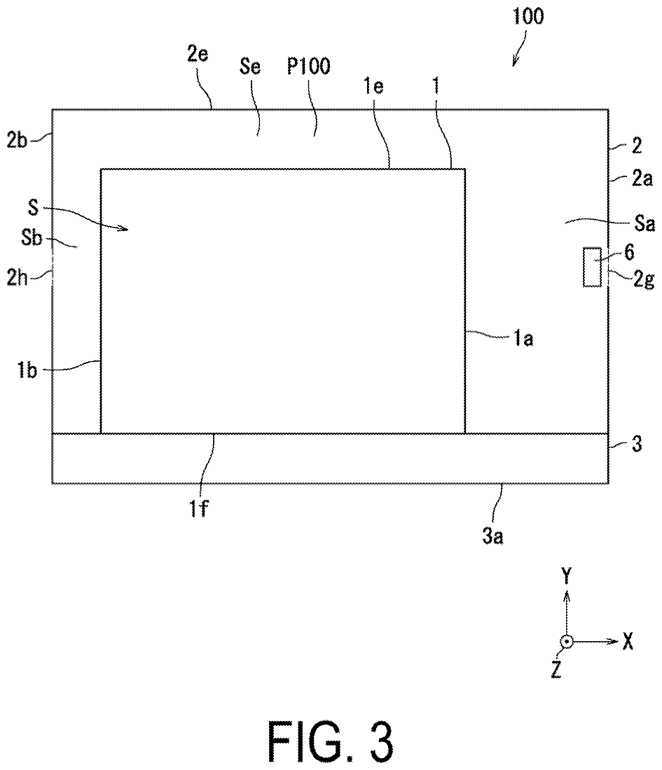

A heating cooking apparatus 100 according to a first embodiment of the disclosure will be described. with reference to FIG. 1 to FIG. 4. FIG. 1 is a schematic front view illustrating an appearance of the heating cooking apparatus 100 according to the first embodiment. Note that, in FIG. 1, a viewing window for directly viewing an inside of a heating chamber 1 is not drawn for ease of understanding. FIG. 2 is a schematic cross-sectional view illustrating, from a front surface side, an internal structure of the heating cooking apparatus 100 according to the first embodiment. FIG. 3 is a schematic cross-sectional view illustrating, from above, the internal structure of the heating cooking apparatus 100 according to the first embodiment.

As illustrated in FIG. 1 and FIG. 2, the heating cooking apparatus 100 includes at least the heating chamber 1, a first detection unit 20, and a first interposed member 30. Further, in this embodiment, the heating cooking apparatus 100 further includes a blower 6. Further, in this embodiment, the heating cooking apparatus 100 further includes a second detection unit 40. Further, in this embodiment, the heating cooking apparatus 100 further includes a speaker 4b. Note that the first interposed member 30 is an example of an “interposed member” of the disclosure. A detailed description is provided below.

The heating cooking apparatus 100 heats and cooks an object to be heated. The object to be heated includes, for example, a food product. The heating cooking apparatus 100 includes the heating chamber 1, a housing 2, and a door 3.

The heating chamber 1 accommodates the object to be heated. Specifically, the heating chamber 1 is a box-like member. The heating chamber 1 includes a heating chamber S that accommodates the object to be heated. The heating chamber S is a space for heating and cooking the object to be heated.

As illustrated in FIG. 2 and FIG. 3, the heating chamber 1 includes a plurality of wall portions. Specifically, the heating chamber 1 includes a side wall 1a, a side wall 1b, an upper wall 1c, a lower wall 1d, a rear wall 1e, and a front wall 1f. Note that each of the side wall 1a, the side wall 1b, the upper wall 1c, the lower wall 1d, the rear wall 1e, and the front wall 1f is an example of a “wall portion” of the disclosure. The front wall 1f is fixed to a back surface side of the door 3. The material of the side wall 1a, the side wall 1b, the upper wall 1c, the lower wall 1d, the rear wall 1e, and the front wall 1f is metal, for example. Note that all or a portion of the front wall 1f may be formed of glass, for example, having translucency and heat resistance so that a user can visually observe the inside of the heating chamber 1.

The housing 2 accommodates the heating chamber 1. The housing 2 includes a plurality of wall portions. Specifically, the housing 2 includes a side wall 2a, a side wall 2b, an upper wall 2c, a lower wall 2d, and a rear wall 2e. The material of the side wall 2a, the side wall 2b, the upper wall 2c, the lower wall 2d, and the rear wall 2e is metal, for example.

As illustrated in FIG. 1 and FIG. 3, the door 3 is disposed on a front surface side of the housing 2. The door 3 opens and closes the heating chamber 1. The door 3 includes a front surface 3a, a handle 3b disposed on an upper portion of the front surface 3a, and an operating unit 3c disposed on the front surface 3a. The operating unit 3c receives an operation from the user. The operating unit 3c includes, for example, a start button 3d, a stop button 3e, and a condition setting button 3f. The start button 3d is a button for starting heating. The stop button 3e is a button for stopping heating. The condition setting button 3f is a button for setting heating conditions, such as a heating time and a heating temperature.

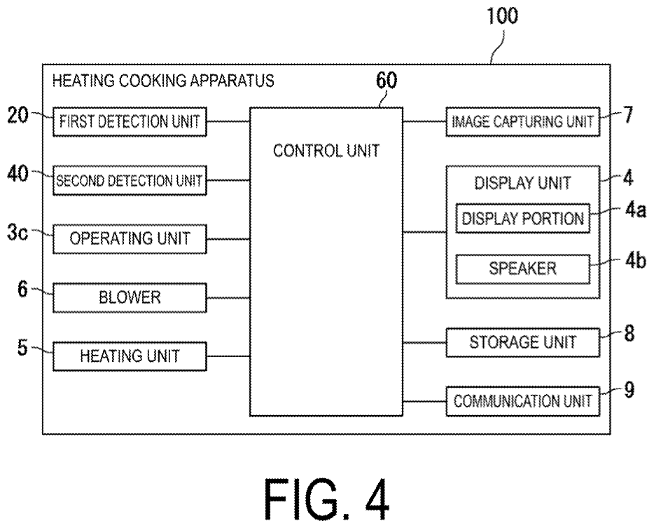

FIG. 4 is a block diagram illustrating a configuration of the heating cooking apparatus 100 according to the first embodiment. As illustrated in FIG. 1 and FIG. 4, the heating cooking apparatus 100 includes the speaker 4b. Further, the heating cooking apparatus 100 includes a display portion 4a. Specifically, the heating cooking apparatus 100 includes a display unit 4. The display unit 4 is disposed on the front surface 3a of the door 3. The display unit 4 includes the display portion 4a and the speaker 4b. The display portion 4a includes a liquid crystal panel, for example. The display portion 4a displays an image. In this embodiment, the display portion 4a displays an image captured by an image capturing unit 7. The speaker 4b outputs sound detected by the first detection unit 20. Accordingly, the sound detected by the first detection unit 20 can be output from the heating cooking apparatus 100.

Further, as illustrated in FIG. 2 and FIG. 4, the heating cooking apparatus 100 includes a heating unit 5. The heating unit 5 heats the food product in the heating chamber 1. The heating unit 5 is, for example, a microwave supply device. The heating unit 5 supplies microwaves to the heating chamber 1. The heating unit 5 is disposed, for example, below the heating chamber 1. Note that the heating unit 5 need not be a microwave supply device as long as capable of heating the food product in the heating chamber 1. For example, the heating unit 5 may be a heater that generates heat. Further, the heating unit 5 may blow high-temperature hot air or high-temperature steam into the heating chamber 1.

Further, as illustrated in FIG. 2 and FIG. 3, the heating cooking apparatus 100 includes the blower 6. The blower 6 circulates air through an air passage P100 of the heating cooking apparatus 100, thereby cooling an interior of the heating cooking apparatus 100. Specifically, the heating cooking apparatus 100 includes the air passage P100. The air passage P100 is constituted by a space Sa, a space Sb, a space Sc, and a space Se. The space Sa is disposed between the side wall 1a of the heating chamber 1 and the side wall 2a of the housing 2. The space Sb is disposed between the side wall 1b and the side wall 2b. The space Sc is disposed between the upper wall 1c and the upper wall 2c. The space Se is disposed between the rear wall 1e and the rear wall 2e. The blower 6 is disposed in the space Sa. The side wall 2a of the housing 2 includes an opening portion 2g for causing air to flow into the housing 2. The side wall 2b includes an opening portion 2h for emitting air to the outside of the housing 2. An air flow is generated by the blower 6 being driven. Then, the air flows into the interior of the heating cooking apparatus 100 via the opening portion 2a. The entered air flows from the space Sa to the space Sb through the space Sc and the space Se. The air that flows to the space Sb is emitted from the opening portion 2h to the outside of the heating cooking apparatus 100. With the air being circulated through the air passage P100, it is possible to suppress a temperature rise in electronic components, for example, disposed in the air passage P100.

In this embodiment, the heating cooking apparatus 100 includes the first detection unit 20 and the first interposed member 30. The first detection unit 20 is spaced apart from the heating chamber. Accordingly, transmission of the heat of the heating chamber 1 to the first detection unit 20 is suppressed, making it possible to suppress a temperature rise in the first detection unit 20.

The first detection unit 20 detects sound in the heating chamber 1. That is, the first detection unit 20 detects a cooking sound in the heating chamber 1. The first interposed member 30 is interposed between the heating chamber 1 and the first detection unit 20. The first interposed member 30 extends from the first detection unit 20 toward the heating chamber 1.

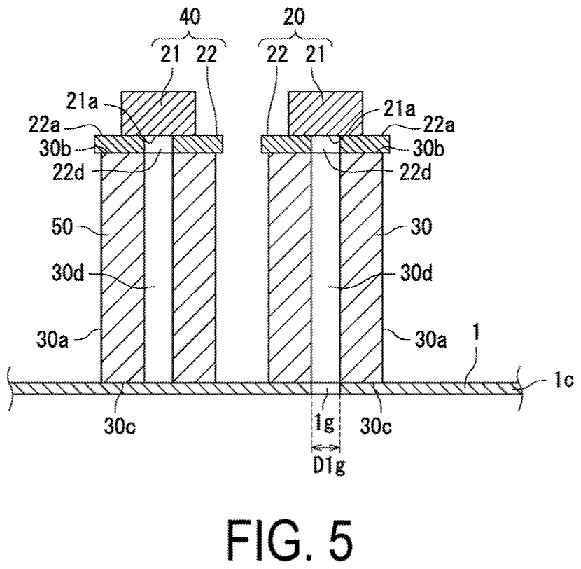

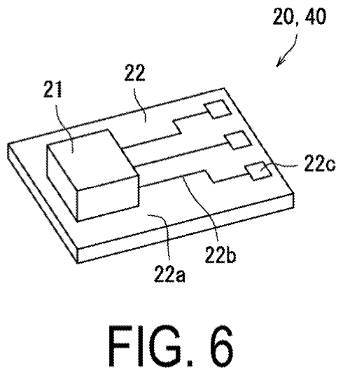

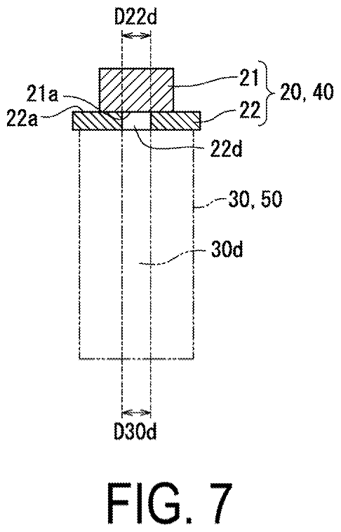

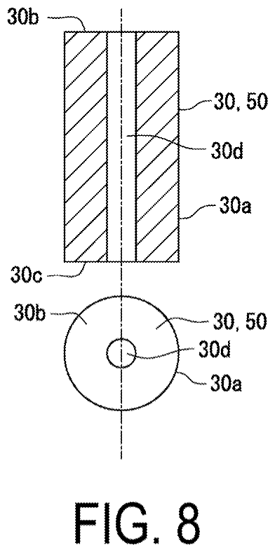

FIG. 5 is a cross-sectional view illustrating a structure around the first detection unit 20, the first interposed member 30, a second detection unit 40, and a second interposed member 50 according to the first embodiment. FIG. 6 is a perspective view illustrating the structure of the first detection unit 20 and the second detection unit 40 according to the first embodiment. FIG. 7 is a cross-sectional view illustrating a structure of the first detection unit 20 and the second detection unit 40 according to the first embodiment. FIG. 8 is a diagram illustrating a structure of the first interposed member 30 and the second interposed member 50 according to the first embodiment. As illustrated in FIG. 5 to FIG. 7, the first detection unit 20 includes a detection element 21 and a substrate 22. The detection element 21 detects sound. The detection element 21 includes, for example, a microelectromechanical systems (MEMS) microphone. The detection element 21 includes a detection surface 21a for detecting the sound. The detection element 21 generates a sound signal on the basis of the detected sound, and transmits the sound signal to a control unit 60 (refer to FIG. 4). Note that the detection element 21 includes a sound hole (not illustrated) for capturing the sound in an interior of the detection element 21, and the sound passing through the sound hole is detected by the detection element 21. In this specification, a surface on which the sound hole is disposed is referred to as the detection surface 21a.

The detection element 21 is fixed to the substrate 22. The substrate 22 is made of, for example, resin. The substrate 22 includes a mounting surface 22a and a plurality of wiring portions 22b disposed on the mounting surface 22a. The detection surface 21a of the detection element 21 is fixed to the mounting surface 22a of the substrate 22. The detection element 21 is electrically connected to the wiring portions 22b. The wiring portions 22b are drawn to the outside of the detection element 21. Each of the wiring portions 22b includes an electrode portion 22c. The electrode portion 22c is electrically connected to the control unit 60. Further, the substrate 22 includes an opening portion 22d that passes through the substrate 22 in a thickness direction. The opening portion 22d passes the sound therethrough.

As illustrated in FIG. 5 and FIG. 8, the first interposed member 30 has an elongated shape. The first interposed member 30 has, for example, a cylindrical shape. The first interposed member 30 has an outer peripheral surface 30a, a first end surface 30b, a second end surface 30c, and a through hole 30d. The first end surface 30b is disposed on the first detection unit 20 side. The first end surface 30b is in close contact with the substrate 22 of the first detection unit 20. An adhesive (not illustrated), for example, may be disposed between the first end surface 30b and the substrate 22. By adhering the first end surface 30b to the substrate 22, it is possible to suppress the entry of sound into the through hole 30d via a gap between the first end surface 30b and the substrate 22. The second end surface 30c is disposed on the heating chamber 1 side. The second end surface 30c is in close contact with the heating chamber 1. An adhesive (not illustrated), for example, may be disposed between the second end surface 30c and the heating chamber 1. By adhering the second end surface 30c to the heating chamber 1, it is possible to suppress the entry of sound into the through hole 30d via a gap between the second end surface 30c and the heating chamber 1.

The through hole 30d passes the sound in the heating chamber 1 therethrough. Accordingly, the sound in the heating chamber 1 reaches the first detection unit 20 via the first interposed member 30, and therefore the first detection unit 20 is capable of detecting the sound in the heating chamber 1. Thus, by outputting the detected sound from the speaker 4b, for example, the user can identify the progress of cooking without visually observing the display portion 4a. Further, compared to a case in which the cooking sound cannot be heard, the user is stimulated in appetite and enjoys the cooking. Note that, in a case in which the first interposed member 30 is not disposed between the first detection unit 20 and the heating chamber 1, the sound in the heating chamber 1 is diffused in the air passage P100 and thus substantially not detected by the first detection unit 20. Further, in a case in, which the first interposed member 30 is not disposed between the first detection unit 20 and the heating chamber 1, a driving sound of the blower 6, for example, in the air passage P100 is detected by the first detection unit 20. The driving sound of the blower 6 is loud compared to the cooking sound in the heating chamber 1 and thus, in a case in which the first interposed member 30 is not disposed, the cooking sound is drowned out by the driving sound of the blower 6. Accordingly, it is difficult to detect the cooking sound by the first detection unit 20. That is, the first interposed member 30 functions to transmit the cooking sound in the heating chamber 1 to the first detection unit 20, and functions to suppress the drowning out of the cooking sound out by noise other than the sound in the heating chamber 1.

The through hole 30d extends from the first detection unit 20 toward the heating chamber 1. Accordingly, the sound in the heating chamber 1 can be transmitted to the first detection unit 20. Specifically, the through hole 30d is formed from the first end surface 30b to the second end surface 30c.

An inner diameter D30d (refer to FIG. 7) of the through hole 30d has a constant size. Accordingly, changes in vibration frequency of the sound passing through the through hole 30d can be suppressed. The through hole 30d is continuous with the opening portion 22d of the substrate 22. Accordingly, the sound can be transmitted from the through hole 30d to the detection element 21 via the opening portion 22d. The inner diameter D30d (refer to FIG. 7) of the through hole 30d has a size substantially identical to that of an inner diameter D22d (refer to FIG. 7) of the opening portion 22d. Accordingly, changes in vibration frequency of the sound at a boundary portion between the through hole 30d and the opening portion 22d can be suppressed.

Further, the inner diameter D30d (refer to FIG. 7) of through hole 30d has a size substantially identical to that of an inner diameter D1g (refer to FIG. 5) of a communication hole 1g of the heating chamber 1. Specifically, the upper wall 1c of the heating chamber 1 includes the communication hole 1g. The communication hole 1g communicates an interior and an exterior of the heating chamber 1. The through hole 30d of the first interposed member 30 is continuous with the communication hole 1g of the heating chamber 1. Accordingly, the sound in the heating chamber 1 is transmitted to the through hole 30d of the first interposed member 30 via the communication hole 1g. Further, the inner diameter D30d (refer to FIG. 7) of the through hole 30d has a size substantially identical to that of the inner diameter D1g (refer to FIG. 5) of the communication hole 1g. Accordingly, changes in vibration frequency of the sound at a boundary portion between the communication hole 1g and the through hole 30d can be suppressed. Note that the communication hole 1g is an example of a “communication hole” of the disclosure.

Further, a heat resistance temperature of the first interposed member 30 is higher than a maximum temperature of the heating chamber 1. Accordingly, deterioration of the first interposed member 30 caused by the temperature of the heating chamber 1 can be suppressed. The maximum temperature of the heating chamber 1 is the maximum temperature reached by the side wall 1a, the side wall 1b, the upper wall 1c, the lower wall 1d, the rear wall 1e, and the front wall 1f of the heating chamber 1 when the heating cooking apparatus 100 is used. For example, in a case in which the heating cooking apparatus 100 is a microwave oven, the maximum temperature of the heating chamber 1 is approximately 100° C. Further, for example, in a case in which the heating cooking apparatus 100 is an oven, the maximum temperature of the heating chamber 1 approximately 250° C. The heat resistance temperature of the first interposed member 30 is, for example, 270° C. or higher. As a material of the first interposed member 30, silicone rubber or Teflon (trademark), for example, can be used.

The first detection unit 20 is disposed in the air passage P100. Accordingly, the first detection unit 20 is cooled by the air being circulated through the air passage P100, making it possible to suppress a temperature rise in the first detection unit 20.

Further, in this embodiment, the heating cooking apparatus 100 includes the second detection unit 40 and the second interposed member 50. The second detection unit 40 is spaced apart from the heating chamber 1. Accordingly, transmission of the heat of the heating chamber 1 to the second detection unit 40 is suppressed, making it possible to suppress a temperature rise in the second detection unit 40.

In this embodiment, the second detection unit 40 has the same structure as that of the first detection unit 20. That is, the second detection unit 40 includes the detection element 21 and the substrate 22. Further, the second interposed member 50 has the same structure as that of the first interposed member 30. That is, the second interposed member 50 includes the through hole 30d. Further, the second interposed member 50 is disposed between the heating chamber 1 and the second detection unit 40. Accordingly, a detailed description of the structure of the second detection unit 40 and the second interposed member 50 will be omitted.

Unlike the first detection unit 20, the second detection unit 40 substantially does not detect the sound in the heating chamber 1. Specifically, unlike the first interposed member 30, the second interposed member 50 faces a portion of the heating chamber 1 where the communication hole 1g is not formed. Accordingly, the sound in the heating chamber 1 is substantially not transmitted into the through hole 30d of the second interposed member 50, and thus the second detection unit 40 substantially does not detect the cooking sound.

Incidentally, in a case in which the noise in the air passage P100 is loud, the first detection unit 20 detects not only the cooking sound in the heating chamber 1, but also the noise in the air passage P100. Specifically, the noise is transmitted into the heating chamber 1 and is detected by the first detection unit 20 via the first interposed member 30. On the other hand, the second detection unit 40 mainly detects sound other than the cooking sound. Accordingly, the noise detected by the first detection unit 20 can be reduced on the basis of the sound detected by the second detection unit 40. Specifically, the second detection unit 40 detects the noise in the air passage P100 substantially without detecting the cooking sound in the heating chamber 1.

The first detection unit 20 and the second detection unit 40 are disposed adjacent to each other. Further, the first detection unit 20 and the second detection unit 40 face the same wall portion (here, the upper wall 1c) of the heating chamber 1. Accordingly, the noise is detected substantially evenly by the first detection unit 20 and the second detection unit 40. Thus, the noise detected by the first detection unit 20 can be easily reduced on the basis of the noise detected by the second detection unit 40.

In this embodiment, the heating cooking apparatus 100 includes the image capturing unit 7. The image capturing unit 7 is spaced apart from the heating chamber 1. Accordingly, transmission. of the heat of the heating chamber 1 to the image capturing unit 7 is suppressed, making it possible to suppress a temperature rise in the image capturing unit 7.

The image capturing unit 7 captures an image of the inside of the heating chamber 1. Accordingly, the image of the inside of the heating chamber 1 captured by the image capturing unit 7 can be displayed on, for example, the display portion 4a. Specifically, the heating chamber 1 includes a communication hole 1h. The communication hole 1h communicates the interior and the exterior of the heating chamber 1. The image capturing unit 7 captures a cooking state of the food product in the heating chamber via the communication hole 1h. The communication hole 1h is disposed in a connecting portion between the side wall 1a and the upper wall 1c, for example. As long as the image capturing unit 7 is capable of capturing the cooking state of the food product, the position of the communication hole 1h is not particularly limited, but is preferably in an upper portion of the heating chamber 1. Further, the image capturing unit 7 generates image data on the basis of the captured image and transmits the image data to the control unit 60.

Further, a transparent member (not illustrated) having heat resistance may be disposed between the communication hole 1h and the image capturing unit 7. In this case, a heat resistance temperature of the transparent member is higher than the maximum temperature of the heating chamber 1. As a material of the transparent member, glass can be used, for example. Further, the image capturing unit 7 can capture an image of the inside of the heating chamber 1 via the transparent member, and thus the transparent member may be disposed in such a manner that, for example, the transparent member blocks the communication hole 1h or covers an imaging lens (not illustrated) of the image capturing unit 7.

Further, as illustrated in FIG. 4, the heating cooking apparatus 100 includes a storage unit 8, a communication unit 9, and the control unit 60. The storage unit 8 includes a storage device, and stores data and computer programs. Specifically, the storage unit 8 includes a main storage device such as a semiconductor memory, and an auxiliary storage device such as a semiconductor memory, a solid state drive, and/or a hard disk drive. The storage unit 8 may include a removable medium. The storage unit 8 stores sound data, image data, and the like under the control of the control unit 60.

The communication unit 9 is an interface device for connecting to a communication network (not illustrated). The communication network is, for example, the internet or a local area network (LAN). In this embodiment, the heating cooking apparatus 100 is capable of communicating with other devices via the communication network. Other devices include at least one of a display portion and a speaker. Examples of other devices include a smart phone and a tablet terminal.

The control unit 60 includes a processor such as a central processing unit (CPU). The control unit 60 controls the operation of the heating unit 5 and the operation of the display unit 4 by executing the programs stored in the storage unit 8.

The control unit 60 receives a sound signal based on the sound detected by the first detection unit 20. The control unit 60 receives a sound signal based on the sound detected by the second detection unit 40. The control unit 60 generates sound data obtained by reducing a noise component of the sound detected by the first detection unit 20 on the basis of the noise detected by the second detection unit 40. In other words, the control unit 60 removes the sound detected by the second detection unit 40 from the sound detected by the first detection unit 20 as a noise component. Then, the control unit 60 generates sound data substantially composed of the cooking sound. Note that, as a method for removing the sound detected by the second detection unit 40 from the sound detected by the first detection unit 20 as a noise component, a beamforming technique and an echo cancellation technique, for example, can be used.

Further, the control unit 60 generates image data on the basis of the captured data received from the image capturing unit 7.

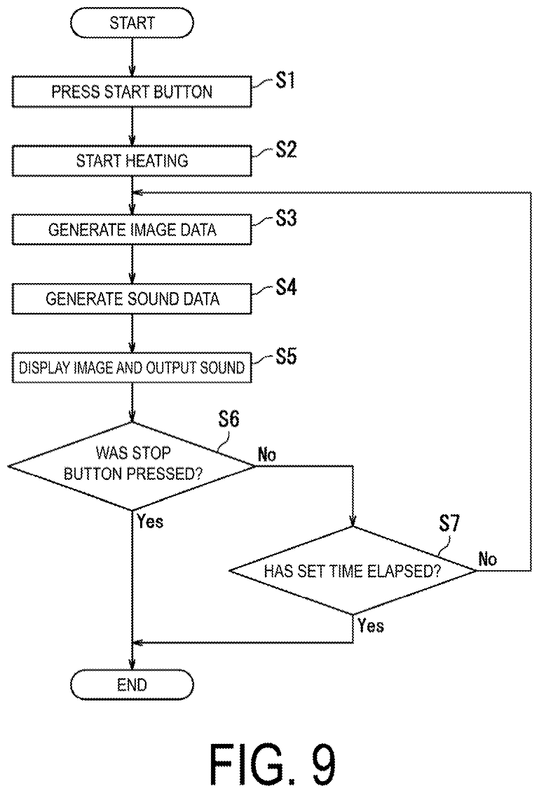

Next, a processing flow of the heating cooking apparatus 100 will be described. FIG. 9 is a diagram illustrating the processing flow of the heating cooking apparatus 100 according to the first embodiment. Note that, for ease of understanding, an example is described in which an image is displayed on and sound is output from the display unit 4. However, the image data and the sound data may be transmitted to another device via the communication unit 9 to display the image on and output sound from the other device.

As illustrated in FIG. 9, in step S1, the heating conditions are set and the start button 3d is subsequently pressed by the user.

In step S2, the control unit 60 starts heating the food product using the heating unit 5. Further, the control unit 60 drives the first detection unit 20, the second detection unit 40, and the image capturing unit 7. Further, the control unit 60 drives the blower 6.

In step S3, the control unit 60 generates image data on the basis of captured data received from the image capturing unit 7.

In step S4, the control unit 60 generates sound data on the basis of sound signals received from the first detection unit 20 and the second detection unit 40. Specifically, on the basis of the noise detected by the second detection unit 40, the control unit 60 generates sound data obtained by reducing the noise component from the sound detected by the first detection unit 20.

In step S5, the control unit 60 displays an image based on the image data on the display portion 4a of the display unit 4. Further, the control unit 60 outputs the sound based on the sound data to the speaker 4b.

In step S6, the control unit 60 determines whether or not the stop button 3e was pressed.

In step S6, in a case in which the control unit 60 determines that the stop button 3e was pressed, the heating process is ended. Specifically, the control unit 60 stops the heating by the heating unit 5. Further, the control unit 60 stops driving the first detection unit 20, the second detection unit 40, the image capturing unit 7, and the blower 6. Further, the control unit 60 stops the display of the image by the display portion 4a, and stops the output of the sound by the speaker 4b.

On the other hand, in step S6, in a case in which the control unit 60 determines that the stop button 3e has not been pressed, the process proceeds to step S7.

In step S7, the control unit 60 determines whether or not the heated time has surpassed a set time.

In step S7, in a case in which the control unit 60 determines that the heated time has not surpassed the set time, the process returns to step S3.

On the other hand, in step S7, in a case in which the control unit 60 determines that the heated time surpassed the set time, the heating process is ended.

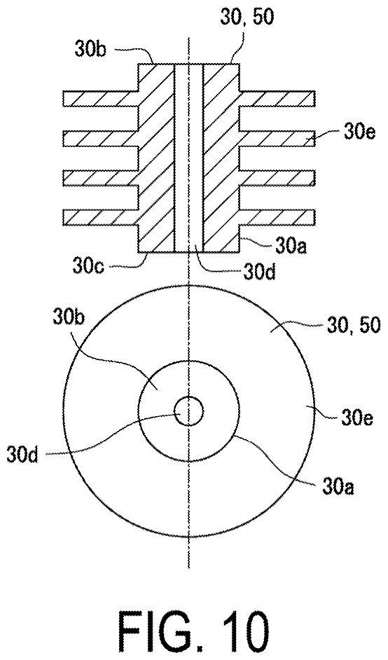

Next, structures of the first interposed member 30 and the second interposed member 50 according to modified examples of the first embodiment will be described with reference to FIG. 10 to FIG. 13. In each of the modified examples, the first interposed member 30 and the second interposed member 50 have the same structure, and thus the structure of the first interposed member 30 will be described.

### First Modified Example

FIG. 10 is a diagram illustrating a structure of the first interposed member 30 and the second interposed member 50 according to a first modified example. As illustrated in FIG. 10, the first interposed member 30 includes the outer peripheral surface 30a, the first end surface 30b, the second end surface 30c, the through hole 30d, and a protruding portion 30e. The protruding portion 30e protrudes outward from the first interposed member 30. Accordingly, a surface area of the first interposed member 30 increases, thereby increasing a heat dissipation of the first interposed member 30. Thus, transmission of the heat of the heating chamber 1 to the first detection unit 20 via the first interposed member 30 is suppressed, making it possible to suppress a temperature rise in the first detection unit 20. Specifically, the protruding portion 30e is disposed on the outer peripheral surface 30a. The protruding portion 30e protrudes outward in a radial direction of the first interposed member 30 from the outer peripheral surface 30a. The protruding portion 30e has a disc shape. The first interposed member 30 includes a plurality of the protruding portions 30e. The plurality of protruding portions 30e are separated from each other in an axial direction of the first interposed member 30.

### Second Modified Example

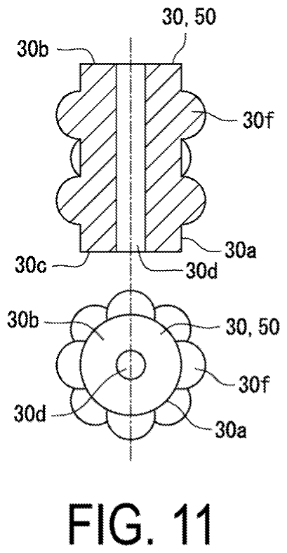

FIG. 11 is a diagram illustrating a structure of the first interposed member 30 and the second interposed member 50 according to a second modified example. As illustrated in FIG. 11, the first interposed member 30 includes the outer peripheral surface 30a, the first end surface 30b, the second end surface 30c, the through hole 30d, and a protruding portion 30f. The protruding portion 30f protrudes outward from the first interposed member 30. Accordingly, the surface area of the first interposed member 30 increases, making it possible to further suppress a temperature rise in the first detection unit 20. Specifically, the protruding portion 30f is disposed on the outer peripheral surface 30a. The protruding portion 30f protrudes outward in the radial direction of the first interposed member 30 from the outer peripheral surface 30a. The protruding portion 30f has a hemispherical shape. The first interposed member 30 includes a plurality of the protruding portions 30f. The plurality of protruding portions 30f are separated from each other in a peripheral direction of the first interposed member 30.

### Third Modified Example

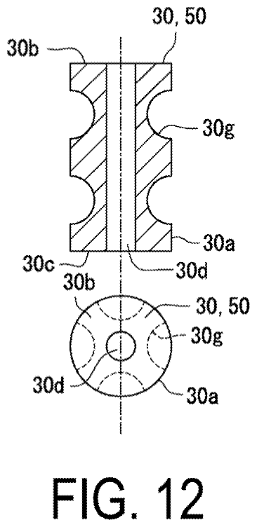

FIG. 12 is a diagram illustrating a structure of the first interposed member 30 and the second interposed member 50 according to a third modified example. As illustrated in FIG. 12, the first interposed member 30 includes the outer peripheral surface 30a, the first end surface 30b, the second end surface 30c, the through hole 30d, and a recessed portion 30g. The recessed portion 30g recesses inward of the first interposed member 30. Accordingly, the surface area of the first interposed member 30 increases, making it possible to further suppress a temperature rise in the first detection unit 20. Specifically, the recessed portion 30g is disposed on the outer peripheral surface 30a. The recessed portion 30g recesses inward from the outer peripheral surface 30a in the radial direction of the first interposed member 30. The recessed portion 30g has a hemispherical shape. The first interposed member 30 includes a plurality of the recessed portions 30g. The plurality of recessed portions 30g are separated from each other in the peripheral direction of the first interposed member 30.

### Fourth Modified Example

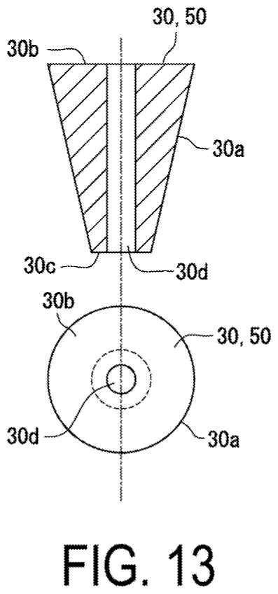

FIG. 13 is a diagram illustrating a structure of the first interposed member 30 and the second interposed member 50 according to a fourth modified example. As illustrated in FIG. 13, the first interposed member 30 includes the outer peripheral surface 30a, the first end surface 30b, the second end surface 30c, and the through hole 30d. The first interposed member 30 has a truncated cone shape. An area of the second end surface 30c is small compared to an area of the first end surface 30b. Accordingly, the area of the first interposed member 30 that comes into contact with the heating chamber 1 is reduced, thereby reducing the amount of heat transmitted from the heating chamber 1 to the first interposed member 30. This makes it possible to suppress a temperature rise in the first interposed member 30 and thus further suppress a temperature rise in the first detection unit 20.

Further, the area of the first end surface 30b is greater than the area of the second end surface 30c, thereby increasing the heat dissipation on the first end surface 30b side of the first interposed member 30. Accordingly, a temperature rise in the first interposed member 30 can be further suppressed.

### Fifth Modified Example

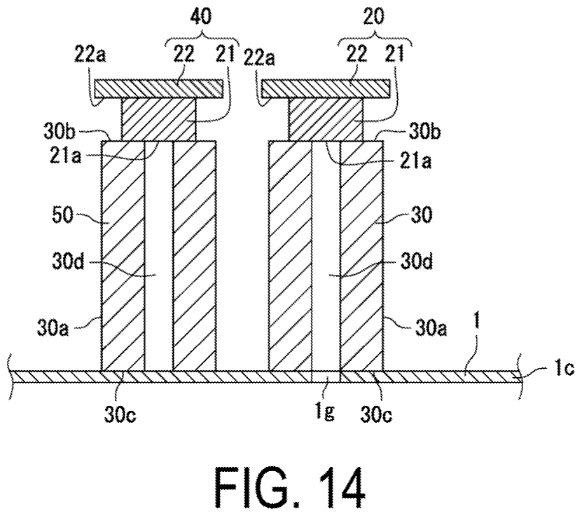

FIG. 14 is a cross-sectional view illustrating a structure around the first detection unit 20, the first interposed member 30, the second detection unit 40, and the second interposed member 50 according to a fifth modified example. As illustrated in FIG. 14, in the first detection unit 20 of the fifth modified example, a surface opposite to the detection surface 21a of the detection element 21 is fixed to the mounting surface 22a of the substrate 22. That is, the detection surface 21a is disposed opposite the substrate 22. The substrate 22 does not include the opening portion 22d. Then, the first end surface 30b of the first interposed member 30 adheres to the detection element 21. In the fifth modified example, similarly to the first embodiment, the sound in the heating chamber 1 reaches the detection surface 21a of the detection element 21 via the through hole 30d of the first interposed member 30. Accordingly, the detection element 21 is capable of detecting the sound in the heating chamber 1. Further, the second detection unit 40 has the same structure as that of the first detection unit 20. Further, the first end surface 30b of the second interposed member 50 is in close contact with the detection element 21. The other structures of the second detection unit 40 are similar to those of the first detection unit 20.

### Second Embodiment

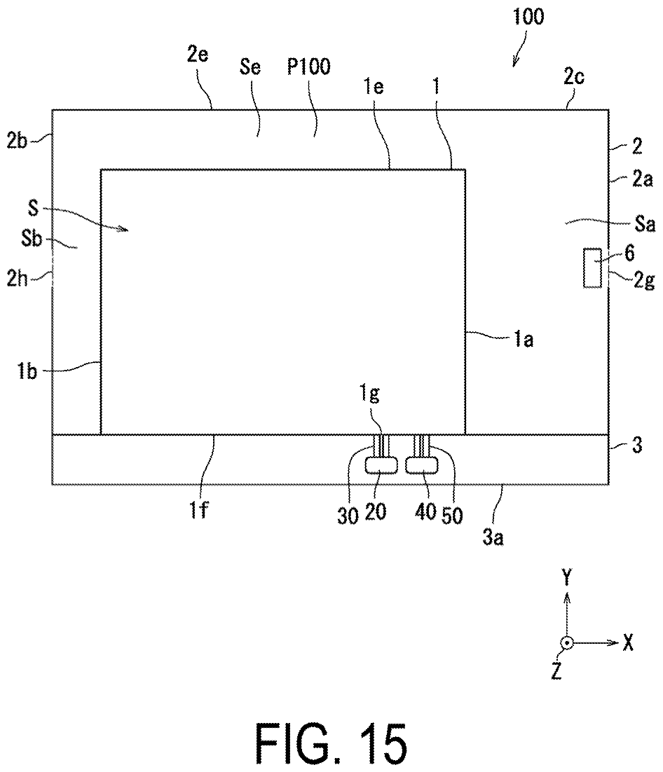

A heating cooking apparatus 100 according to a second embodiment of the disclosure will be described with reference to FIG. 15. In the second embodiment, an example is described in which a first detection unit 20 is disposed in a door 3, unlike the first embodiment. FIG. 15 is a schematic cross-sectional view illustrating, from above, an internal structure of the heating cooking apparatus 100 according to the second embodiment of the disclosure.

As illustrated in FIG. 15, the heating cooking apparatus 100 of this embodiment includes at least a heating chamber 1, the first detection unit 20, and a first interposed member 30. Further, the heating cooking apparatus 100 further includes a second detection unit 40. Further, the heating cooking apparatus 100 further includes a second interposed member 50.

In this embodiment, the first detection unit 20 is disposed in the door 3. Here, a side wall 2a, a side wall 2b, an upper wall 2c, a lower wall 2d, and a rear wall 2e of the heating cooking apparatus 100 may be disposed close to a wall or the like of a room. In this case, air readily accumulates and heat is readily held between the side wall 2a, the side wall 2b, the upper wall 2c, the lower wall 2d, the rear wall 2e, and the wall or the like of the room. Thus, a temperature of the side wall 2a, the side wall 2b, the upper wall 2c, the lower wall 2d, and the rear wall 2e is less likely to decrease. On the other hand, the door 3 faces an open space, and thus a temperature of the door 3 is likely to decrease compared to the temperature of the side wall 2a, the side wall 2b, the upper wall 2c, the lower wall 2d, and the rear wall 2e. Thus, by disposing the first detection unit 20 in the door 3, it is possible to suppress a temperature rise in the first detection unit 20. Further, even in a case in which a blower 6 is disposed in a housing 2, it is possible to suppress detection of the driving sound of the blower 6 by the first detection unit 20.

Similarly to the first embodiment, the first detection unit 20 is spaced apart from the heating chamber 1. Accordingly, the transmission of the heat of the heating chamber 1 to the first detection unit 20 is suppressed, making it possible to suppress a temperature rise in the first detection unit 20. Further, the first interposed member 30 is interposed between the heating chamber 1 and the first detection unit 20.

In this embodiment, a front wall 1f of the heating chamber 1 includes a communication hole 1g. A through hole 30d of the first interposed member 30 is continuous with the communication hole 1a of the front wall 1f.

Further, in this embodiment, the second detection unit 40 is disposed in the door 3. The second detection unit 40 is spaced apart from the front wall 1f of the heating chamber 1 Further, the first detection unit 20 and the second detection unit 40 are disposed adjacent to each other.

Other structures and other effects of the second embodiment are similar to those of the first embodiment.

### Third Embodiment

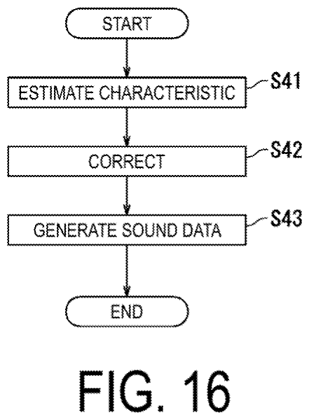

A method of generating sound data by a control unit 60 according to a third embodiment of the disclosure will now be described with reference to FIG. 16. In the third embodiment, unlike the first embodiment and the second embodiment, an example of estimating a characteristic of the transmission of sound other than the cooking sound to a first detection unit 20 and a second detection unit 40 will be described. FIG. 16 is a diagram illustrating a generation flow of the sound data by the control unit 60 according to the third embodiment of the disclosure. Note that, here, for ease of understanding, among the processes executed by the control unit 60, the process of generating the sound data will be described. Step S41 to step S43 of FIG. 16 correspond to step S4 of FIG. 9.

In this embodiment, the control unit 60 estimates, on the basis of the sound detected by the first detection unit 20 and the second detection unit 40 after heating initiation, the characteristic of the transmission of sound other than the cooking sound to the first detection unit 20 and the second detection unit 40. Subsequently, on the basis of the estimated characteristic, the control unit 60 corrects the sound signal indicating the sound detected by the second detection unit 40. Then, the control unit 60 generates sound data on the basis of the sound signal indicating the sound detected by the first detection unit 20 and the corrected sound signal. Accordingly, the noise component can be removed with high accuracy from the sound detected by the first detection unit 20.

Specifically, as illustrated in FIG. 16, the heating of the food product is started, which starts the process of generating sound data.

Here, substantially no cooking sound occurs in a heating chamber 1 immediately after heating initiation, and therefore substantially all sound detected by the first detection unit 20 and the second detection unit 40 is sound other than the cooking sound. Thus, in step S41, the control unit 60 estimates, as a transmission function, a characteristic of a path in which noise, such as a mechanical vibration sound, is transmitted to the first detection unit 20 and the second detection unit 40, on the basis of the sound detected by the first detection unit 20 and the second detection unit 40 immediately after heating initiation. Note that “immediately after heating initiation” means until a predetermined amount of time elapses after heating initiation. Further, “immediately after heating initiation” means until sound is emitted from an object to be heated after heating initiation. Specifically, “immediately after heating initiation” means until a period of a few seconds or tens of seconds has elapsed after heating initiation. The estimation of the characteristic of step S41 completed before a predetermined amount of time has elapsed after heating initiation.

In step S42, the control unit 60 corrects the sound signal indicating the sound detected by the second detection unit 40 using the estimated characteristic (transmission function).

In step S43, the control unit 60 generates the sound data by reducing, as a noise component, the corrected sound signal from the sound signal indicating the sound detected by the first detection unit 20.

Note that the method of generating sound data described in the third embodiment can be combined with the processing flow of the heating cooking apparatus 100 described in the first embodiment. In this case, the sound data generated in step S43 is used as the sound data generated in step S4.

The embodiments of the disclosure have been described above with reference to the drawings. However, the disclosure is not limited to the embodiments described above, and it is possible to implement the disclosure in various modes without departing from the gist of the disclosure. Further, the disclosure can be made in various forms by appropriately combining a plurality of components disclosed in the embodiments described above. For example, several components may be deleted from all of the components described in the embodiments. Furthermore, the components across different embodiments may be appropriately combined. For easier understanding, the drawings schematically illustrate the respective main components, and the thickness, length, number, interval or the like of illustrated components may differ from actuality for the sake of convenience in creating the drawings. The material, shape, dimensions, and the like of each of the components illustrated in the embodiments described above are merely exemplary and are not particularly limited, and various modifications can be made within due scope not departing from the effects of the disclosure in essence.

For example, in the first embodiment and the second embodiment described above, an example is given in which the heating cooking apparatus includes the second detection unit, but the heating cooking apparatus need not include the second detection unit. For example, noise components may be reduced by only one first detection unit, for example, by using noise suppression technology.

Further, in the first modified example to the third modified example illustrated in FIG. 10 to FIG. 12, examples are given in which the first interposed member includes the protruding portion or the recessed portion, but the disclosure is not limited to these examples. For example, the first interposed member may include both the protruding portion and the recessed portion disposed on the outer peripheral surface.

Further, in the first embodiment described above, an example is given in which the heating cooking apparatus includes the image capturing unit, the display portion, and the speaker, but the disclosure is not limited to this example. The heating cooking apparatus need not include these. In this case, the heating cooking apparatus may, for example, transmit sound data to another device via the communication unit to output only the sound to the other device.

Further, in the first embodiment and the second embodiment described above, an example is given in which the first detection unit and the second detection unit are disposed adjacent to each other, but the disclosure is not limited to this example. For example, the second detection unit may be adjacent to the blower, which is a generation source of noise.

Further, in the first embodiment, an example is given in which the first detection unit is disposed in the upper wall, but the first detection unit may be disposed in the front wall, the rear wall, the side wall, or the lower wall.

Further, in the first embodiment and the second embodiment described above, an example is given in which the heating cooking apparatus includes one each of the first detection unit and the second detection unit, but the disclosure is not limited to this example. For example, the heating cooking apparatus may include a plurality of the first detection units and a plurality of the second detection units.

Further, for example, in FIG. 5 and FIG. 14, an example is given in which the detection surface of the detection element is disposed substantially parallel with the mounting surface of the substrate, but the disclosure is non limited to this example. That is, the detection surface of the detection element may be disposed not substantially parallel to the mounting surface of the substrate. For example, the detection surface of the detection element may be disposed extending in a direction intersecting the mounting surface of the substrate.

Further, in the first embodiment and the second embodiment described above, an example is given in which the heating chamber includes the communication hole and the first interposed member is disposed continuous with the communication hole, but the heating chamber need not include the communication hole. For example, a portion of the heating chamber is thinly formed in comparison to other portions. The thinly formed portion readily vibrates and transmits sound in comparison to the other portions. Thus, by disposing the first interposed member and the first detection unit facing the thinly formed portion, it is possible to detect the sound in the heating chamber. Note that the second interposed member is disposed facing a portion not thinly formed.

Further, the control unit may stop the heating unit or increase or decrease the output of the heating unit on the basis of, for example, a change in frequency of the cooking sound, a change in amplitude of the cooking sound, or a change in number of the generated cooking sounds per unit time.

### INDUSTRIAL APPLICABILITY

The disclosure is useful in the field of a heating cooking apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A heating cooking apparatus comprising:
a heating chamber configured to accommodate an object to be heated;
a first detection unit spaced apart from the heating chamber and configured to detect sound in the heating chamber; and
an interposed member interposed between the heating chamber and the first detection unit and extending from the first detection unit toward the heating chamber,
wherein the interposed member includes a through hole configured to pass the sound.

2. The heating cooking apparatus according to claim 1,
wherein a heat resistance temperature of the interposed member is higher than a maximum temperature of the heating chamber.

3. The heating cooking apparatus according to claim 1,
wherein the through hole extends from the first detection unit toward the heating chamber.

4. The heating cooking apparatus according to claim 1,
wherein an inner diameter of the through hole has a constant size.

5. The heating cooking apparatus according to claim 1,
wherein the heating chamber includes a communication hole communicating an interior and an exterior of the heating chamber, and
the through hole is continuous with the communication hole.

6. The heating cooking apparatus according to claim 5,
wherein an inner diameter of the communication hole has a size substantially identical to a size of an inner diameter of the through hole.

7. The heating cooking apparatus according to claim 1,
wherein the interposed member includes
an outer peripheral surface, and
at least one of a protruding portion and a recessed portion disposed on the outer peripheral surface,
the protruding portion protrudes outward from the interposed member, and
the recessed portion recesses inward of the interposed member.

8. The heating cooking apparatus according to claim 1,
wherein the first detection unit includes
a detection element configured to detect sound, and
a substrate with the detection element fixed to the substrate,
the substrate includes an opening portion passing through the substrate in a thickness direction, and
the opening portion is continuous with the through hole.

9. The heating cooking apparatus according to claim 8,
wherein an inner diameter of the opening portion has a size substantially identical to a size of an inner diameter of the through hole.

10. The heating cooking apparatus according to claim 1, further comprising:
a second detection unit spaced apart from the heating chamber,
wherein the first detection unit is configured to detect at least a cooking sound inside the heating chamber, and
the second detection unit is configured to detect sound other than the cooking sound.

11. The heating cooking apparatus according to claim 10,
wherein the heating chamber is constituted by a plurality of wall portions, and
the first detection unit and the second detection unit are adjacent to each other and face an identical wall portion of the plurality of wall portions.

12. The heating cooking apparatus according to claim 10, further comprising:
a control unit,
wherein the control unit is configured to
estimate, on a basis of the at least a cooking sound detected by the first detection unit and the sound other than the cooking sound detected by the second detection unit after heating initiation, a characteristic of transmission of the sound other than the cooking sound to the first detection unit and the second detection unit,
correct a sound signal indicating the sound other than the cooking sound detected by the second detection unit on a basis of the characteristic being estimated, and
generate sound data on a basis of a sound signal indicating the at least a cooking sound detected by the first detection unit and the sound signal being corrected.

13. The heating cooking apparatus according to claim 1, further comprising:
a housing configured to accommodate the heating chamber; and
a blower disposed between the housing and the heating chamber,
wherein an air passage that allows air generated by the blower to flow through the air passage is formed between the housing and the heating chamber, and
the first detection unit is disposed in the air passage.

14. The heating cooking apparatus according to claim 1, further comprising:
a housing configured to accommodate the heating chamber; and
a door disposed on a front surface side of the housing and configured to open and close the heating chamber,
wherein the first detection unit is disposed in the door.

15. The heating cooking apparatus according to claim 1, further comprising:
a speaker configured to output the at least a cooking sound detected by the first detection unit.

16. The heating cooking apparatus according to claim 15, further comprising:
an image capturing unit spaced apart from the heating chamber and configured to capture an image of an inside of the heating chamber; and
a display portion configured to display the image captured by the image capturing unit.
